(19) United States
(12) Patent Application Publication
(10) Pub. No.: US 2011/0180045 A1
(43) Pub. Date: Jul. 28, 2011

(54) IGNITION TIMING CONTROL APPARATUS AND METHOD FOR INTERNAL COMBUSTION ENGINE

(75) Inventors: Youhei Hosokawa, Susono-shi (JP); Tomohiro Shinagawa, Sunto-gun (JP)

(73) Assignee: TOYOTA JIDOSHA KABUSHIKI KAISHA, TOYOTA-SHI, AICHI-KEN (JP)

(21) Appl. No.: 13/057,077

(22) PCT Filed: Sep. 2, 2009
(86) PCT No.: PCT/IB2009/006719

§ 371 Date: Feb. 1, 2011

(30) Foreign Application Priority Data
Oct. 10, 2008 (JP) 2008-264449

(51) Int. Cl. F02P 5/15; F02D 15/00

(52) U.S. Cl. 123/48 R; 123/406.19; 123/406.23

(57) ABSTRACT

When the amount of fresh air drawn into a combustion chamber is designated Ma and the amounts of exhaust gas recirculated into the combustion chamber by external and internal recirculation mechanisms are designated Megre and Megri, respectively, the exhaust gas recirculation rate (Regre) is defined as (Megre+Megri)/(Ma+Megre+Megri). The base ignition timing applied when Regr=0 is set based on the operating state of an internal combustion engine. An advance amount (IGad) is set such that the characteristic of an increase in IGad with respect to an increase in Regr is a downward convex characteristic. The ultimate ignition timing is set to a timing that is advanced from the base ignition timing by the advance amount (IGad).

### BACKGROUND OF THE INVENTION

1. Field of the Invention

The invention relates to an ignition timing control apparatus and method for an internal combustion engine.

2. Description of the Related Art

An internal combustion engine which is provided with an exhaust gas recirculation (EGR) mechanism that recirculates exhaust gas discharged from a combustion chamber back to the intake air side (and therefore back into the combustion chamber) is widely known. Known exhaust gas recirculation mechanisms include an external recirculation mechanism and an internal recirculation mechanism. The external recirculation mechanism controls the amount of exhaust gas recirculated from an exhaust passage to an intake passage through an exhaust gas recirculation passage that connects the intake passage with the exhaust passage, by controlling the opening amount of an exhaust gas recirculation valve interposed in the exhaust gas recirculation passage. The internal recirculation mechanism controls the amount of exhaust gas recirculated from the exhaust gas passage to the intake passage through the combustion chamber by controlling the length of time that the intake valve and the exhaust valve are both simultaneously kept open (i.e., the overlap period). Recirculating exhaust gas back into the combustion chamber using the exhaust gas recirculation mechanism makes it possible to both suppress oxides of nitrogen (NOₓ) from being discharged due to a drop in combustion temperature, and improve fuel efficiency due to a decrease in what is referred to as pumping loss.

When exhaust gas is recirculated into the combustion chamber, the rate of combustion (i.e., combustion propagation) in the combustion chamber decreases and the time from when a spark is generated by the spark plug until the fuel ignites (i.e., ignition delay time) becomes longer due to the drop in combustion temperature and the like. As a result, the timing of the peak in the combustion pressure from combustion is later, which may cause problems such as a reduction in output torque or misfiring or the like. One conceivable way to prevent such problems from occurring is to advance the ignition timing (i.e., the timing at which a command to ignite the air-fuel mixture in the combustion chamber is output). In addition, the decrease in combustion temperature suppresses knocking even if the ignition timing is advanced. Hence, technology which advances the ignition timing when exhaust gas is being recirculated into the combustion chamber is known (see Japanese Patent Application Publication No. 2007-16609 (JP-A-2007-16609), for example).

However, the extent to which the ignition timing is advanced, i.e., how the advance amount is set, is critical when advancing the ignition timing while exhaust gas is being recirculated into the combustion chamber. Hereinafter, all of the gas drawn into the combustion chamber (per one intake stroke) will be referred to as the “total amount of gas”, the total amount of exhaust gas that is recirculated into the combustion chamber (per one intake stroke) by the exhaust gas recirculation mechanism will be referred to as the “total amount of recirculated gas”, and the ratio of the total amount of recirculated gas to the total amount of gas will be referred to as the “exhaust gas recirculation rate”.

The advance amount is typically set so that it is proportionate to the exhaust gas recirculation rate. In this case, the advance amount is set such that the gradient of increase in the advance amount with respect to the increase in the exhaust gas recirculation rate is constant regardless of the exhaust gas recirculation rate. In this case, when the gradient (constant) of the increase in the advance amount is small, the advance amount will be insufficient in an operating region where the exhaust gas recirculation rate is particularly high, possibly resulting in problems such as misfiring. This is thought to be because the rate of combustion of the fuel rapidly decreases and the ignition delay time becomes drastically longer in the operating region where the exhaust gas recirculation rate is particularly high.

If the gradient (constant) of the increase in the advance amount is increased to prevent this, the advance amount will be excessive in the operating region where the exhaust gas recirculation rate is particularly low, which may result in problems such as a decrease in output torque as well as knocking. In other words, when the gradient of the increase in the advance amount with respect to the increase in the exhaust gas recirculation rate is constant regardless of the exhaust gas recirculation rate, it is not possible to simultaneously solve the problem of an insufficient advance amount in the operating region where the exhaust gas recirculation rate is particularly high and the problem of an excessive advance amount in the operating region where the exhaust gas recirculation rate is particularly low no matter how the gradient (constant) of the increase in the advance amount is set.

### SUMMARY OF THE INVENTION

This invention thus provides an ignition timing control apparatus and method for an internal combustion engine, which is able to set an ignition timing that can stably suppress a decrease in output torque, as well as knocking and misfiring and the like, regardless of the exhaust gas recirculation rate when exhaust gas is being recirculated into the combustion chamber.

A first aspect of the invention relates to an ignition timing control apparatus of an internal combustion engine, which includes an exhaust recirculation mechanism and ignition timing setting means for setting an ignition timing based on an operating state of the internal combustion engine. In this aspect, the exhaust gas recirculation mechanism may include an external recirculation mechanism and/or an internal recirculation mechanism.

The ignition timing control apparatus of the first aspect is characterised in that the ignition timing setting means sets the ignition timing such that a gradient of an increase in the amount that the ignition timing is advanced with respect to an increase in the exhaust gas recirculation rate increases as the exhaust gas recirculation rate increases.

More specifically, the ignition timing setting means may include base ignition timing setting means for setting a base ignition timing which is an ignition timing (that corresponds to when the exhaust gas recirculation rate is zero), based on the operating state of the internal combustion engine, and advance amount setting means for setting an advance amount such that the gradient of the increase in the advance amount of the ignition timing with respect to the increase in the exhaust gas recirculation rate increases as the exhaust gas recirculation rate increases. Further, the ignition timing setting means may set the ignition timing to be a timing that is advanced from the base ignition timing by the advance amount.

According to this structure, the characteristic of the increase in the advance amount with respect to the increase in the exhaust gas recirculation rate is a so-called “downward convex” characteristic. Therefore, unlike when the gradient of the increase in the advance amount with respect to the increase in the exhaust gas recirculation rate is constant as described above, the characteristic of the increase in the advance amount with respect to the increase in the exhaust gas recirculation rate can be set such that both the problem of an insufficient advance amount in the operating region where the exhaust gas recirculation rate is particularly high and the problem of an excessive amount of advance amount in the operating region where the exhaust gas recirculation rate is particularly low can be solved simultaneously. As a result, the ignition timing can be set to a timing that is able to stably suppress a decrease in output torque, as well as knocking and misfiring and the like, regardless of the exhaust gas recirculation rate.

In structure described above, the exhaust gas recirculation mechanism and the internal recirculation mechanism may both be provided as the exhaust gas recirculation mechanism. The amount of exhaust gas recirculated (per one intake stroke) into the combustion chamber by the external recirculation mechanism will be referred to as the “external exhaust gas recirculation amount”, the amount of exhaust gas recirculated (per one intake stroke) into the combustion chamber by the internal recirculation mechanism will be referred to as the “internal exhaust gas recirculation amount”, and the ratio of the external exhaust gas recirculation amount to the sum of the external exhaust gas recirculation amount and the internal exhaust gas recirculation amount (i.e., the total amount of recirculated exhaust gas) will be referred to as the “external exhaust gas recirculation rate”. Also, the exhaust gas recirculated into the combustion chamber by the external recirculation mechanism will be referred to as “external recirculated gas”, and the exhaust gas recirculated into the combustion chamber by the internal recirculation mechanism will be referred to as “internal recirculated gas”.

In this case, the ignition timing may be set to a timing that is more advanced the higher the external exhaust gas recirculation rate is. More specifically, the advance amount may be set to a larger value the higher the external exhaust gas recirculation rate is.

The external recirculated gas is gas that is recirculated from the exhaust passage to the intake passage (and therefore the combustion chamber) through the exhaust gas recirculation passage (which may have a cooler or the like interposed therein) which is at a relatively low temperature. The internal recirculated gas is gas that is recirculated from the exhaust passage to the intake passage (and therefore the combustion chamber) through the combustion chamber which is at a high temperature. Therefore, the temperature of the external recirculated gas is typically lower than the temperature of the internal recirculated gas. The temperature of unburned gas in the combustion chamber at top dead center of the compression stroke (hereinafter referred to as the “compression end temperature”) becomes lower as the external exhaust gas recirculation rate increases when the exhaust gas recirculation rate is constant. As a result, the combustion temperature decreases so the rate of combustion becomes slower and the ignition delay time becomes longer, as described above.

In the structure described above, the ignition timing may be set to a timing that is more advanced (or more specifically, the advance amount may be set to a larger value) the higher the external exhaust gas recirculation rate is when the exhaust gas recirculation rate is constant. Accordingly, problems such as misfiring can be inhibited even more when the external exhaust gas recirculation rate is particularly high.

Also, in this structure, the ignition timing may be set to a timing that is more advanced the smaller the total amount of gas is. More specifically, the advance amount may be set to a larger value the smaller the total amount of gas is.

Typically, the compression end temperature decreases as the total amount of gas decreases when the exhaust gas recirculation rate is constant. In this structure, the ignition timing may be set to a timing that is more advanced (or more specifically, the advance amount may be set to a larger value) the smaller the total amount of gas is when the exhaust gas recirculation rate is constant. Accordingly, problems such as misfiring can be inhibited even more when the total amount of gas is particularly small.

Also, in this structure, the ignition timing may be set to a timing that is more advanced the lower the operating speed of the internal combustion engine is. More specifically, the advance amount may be set to a larger value the lower the operating speed is.

The compression stroke takes longer the lower the operating speed is, so more heat from the compressed gas in the combustion chamber is lost to the outside through the walls of the combustion chamber. As a result, the compression end temperature decreases as the operating speed becomes lower when the exhaust gas recirculation rate is constant. In this structure, the ignition timing may be set to a timing that is more advanced (or more specifically, the advance amount may be set to a larger value) the lower the operating speed is when the exhaust gas recirculation rate is constant. Accordingly, problems such as misfiring can be inhibited even more when the operating speed is particularly low.

Further, in the structure described above, an intake valve closing timing control mechanism may also be provided which changes the closing timing of the intake valve based on the operating state of the internal combustion engine. In this case, the ignition timing may be set to a timing that is more advanced the more retarded the closing timing of the intake valve is. More specifically, the advance amount may be set to a larger value the more retarded the closing timing of the intake valve is.

The timing (i.e., crank angle) at which the gas inside the combustion chamber starts to be compressed during the compression stroke is later, and thus the actual compression ratio is smaller, the more retarded the closing timing of the intake valve is. As a result, the compression end temperature becomes lower the more retarded the closing timing of the intake valve is when the exhaust gas recirculation rate is constant. In this structure, the ignition timing may be set to a timing that is more advanced (or more specifically, the advance amount may be set to a larger value) the more retarded the closing timing of the intake valve is when the exhaust gas recirculation rate is constant. Accordingly, problems such as misfiring can be inhibited even more when the closing timing of the intake valve is particularly retarded.

Also, in this structure, an engine compression ratio control mechanism may also be provided which changes an engine compression ratio (i.e., a value obtained by dividing the volume of the combustion chamber at bottom dead center of the compression stroke by the volume of the combustion chamber at top dead center of the compression stroke) based on the operating state of the internal combustion engine. In this case, the ignition timing may be set to a timing that is more advanced the smaller the engine compression ratio is. More specifically, the advance amount may be set to a larger value the smaller the engine compression ratio is.

The compression end temperature becomes lower as the engine compression ratio becomes smaller. In this structure, the ignition timing may be set to a timing that is more advanced (or more specifically, the advance amount may be set to a larger value) the more lower the engine compression ratio is when the exhaust gas recirculation rate is constant. Accordingly, problems such as misfiring can be inhibited even more when the engine compression ratio is particularly low.

Also, the ignition timing control apparatus described above may also be provided with a flowrate control mechanism that changes the flowrate of gas that flows from the intake passage into the combustion chamber (or changes the minimum opening area of the intake passage), based on the operating state of the internal combustion engine. In this case, the ignition timing may be set to a timing that is more advanced the smaller the gas flowrate is (or the larger the minimum opening area of the intake passage is). More specifically, the advance amount may be set to a larger value the smaller the gas flowrate is (or the larger the minimum opening area of the intake passage is).

The turbulence of the gas that is drawn into the combustion chamber decreases as the flowrate of the intake air decreases. As the turbulence of the gas decreases, the opportunity for fuel to come into contact with oxygen in the combustion chamber decreases, so the rate of combustion slows and the ignition delay time becomes longer. In the structure described above, the ignition timing may be set to a timing that is more advanced (or more specifically, the advance amount may be set to a larger value) the smaller the gas flowrate is (or the larger the minimum opening area of the intake passage is). This structure is based on related knowledge. Accordingly, problems such as misfiring can be inhibited even more when the gas flowrate is small (or when the minimum opening area of the intake passage is large).

In the structure described above, the flowrate control mechanism may change the flowrate of gas that flows into the combustion chamber by changing i) the number of valves, from among a plurality of the intake valves (32), that are open or ii) the minimum opening area of the intake passage.

A second aspect of the invention relates to a control method of an ignition timing control apparatus of an internal combustion engine, which includes an exhaust gas recirculation mechanism that recirculates exhaust gas discharged from a combustion chamber of the internal combustion engine into the combustion chamber, and ignition timing setting means for setting an ignition timing, which is the timing at which an air-fuel mixture is ignited in the combustion chamber, based on an operating state of the internal combustion engine. This control method includes calculating an exhaust gas recirculation rate which is the ratio of the total amount of recirculated exhaust gas, i.e., the total amount of exhaust gas recirculated into the combustion chamber by the exhaust gas recirculation mechanism, with respect to the total amount of gas, i.e., the total amount of gas drawn into the combustion chamber; and setting the ignition timing such that a gradient of an increase in the amount that the ignition timing is advanced with respect to an increase in the exhaust gas recirculation rate calculated by the exhaust gas recirculation rate calculating means increases as the exhaust gas recirculation rate calculated by the exhaust gas recirculation rate calculating means increases.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a block diagram schematically showing a system in which an ignition timing control apparatus according to an example embodiment of the invention has been applied to a spark ignition multiple cylinder internal combustion engine;

FIG. 2 is a flowchart illustrating a routine for executing ignition timing control which is executed by a CPU shown in FIG. 1;

FIG. 3 is a graph showing a table that defines the relationship between the exhaust gas recirculation rate and the advance amount of the ignition timing, which is referenced by the CPU shown in FIG. 1;

FIG. 4 is a flowchart illustrating a routine for executing ignition timing control which is executed by a CPU of an ignition timing control apparatus according to a first modified example of the example embodiment of the invention;

FIG. 5 is a graph showing a table that defines the relationship between the external exhaust gas recirculation rate and a coefficient for correcting the advance amount, which is referenced by the CPU of the ignition timing control apparatus according to the first modified example of the example embodiment of the invention;

FIG. 6 is a flowchart illustrating a routine for executing ignition timing control which is executed by a CPU of an ignition timing control apparatus according to a second modified example of the example embodiment of the invention;

FIG. 7 is a graph showing a table that defines the relationship between the total amount of gas and a coefficient for correcting the advance amount, which is referenced by the CPU of the ignition timing control apparatus according to the second modified example of the example embodiment of the invention;

FIG. 8 is a flowchart illustrating a routine for executing ignition timing control which is executed by a CPU of an ignition timing control apparatus according to a third modified example of the example embodiment of the invention;

FIG. 9 is a graph showing a table that defines the relationship between the engine speed and a coefficient for correcting the advance amount, which is referenced by the CPU of the ignition timing control apparatus according to the third modified example of the example embodiment of the invention;

FIG. 10 is a flowchart illustrating a routine for executing ignition timing control which is executed by a CPU of an ignition timing control apparatus according to a fourth modified example of the example embodiment of the invention;

FIG. 11 is a graph showing a table that defines the relationship between the closing timing of an intake valve and a coefficient for correcting the advance amount, which is referenced by the CPU of the ignition timing control apparatus according to the fourth modified example of the example embodiment of the invention;

FIG. 12 is a flowchart illustrating a routine for executing ignition timing control which is executed by a CPU of an ignition timing control apparatus according to a fifth modified example of the example embodiment of the invention;

FIG. 13 is a graph showing a table that defines the relationship between the engine compression ratio and a coefficient for correcting the advance amount, which is referenced by the CPU of the ignition timing control apparatus according to the fifth modified example of the example embodiment of the invention;

FIG. 14 is a flowchart illustrating a routine for executing ignition timing control which is executed by a CPU of an ignition timing control apparatus according to a sixth modified example of the example embodiment of the invention;

FIG. 15 is a graph showing a table that defines the relationship between the state of a swirl control valve and a coefficient for correcting the advance amount, which is referenced by the CPU of the ignition timing control apparatus according to the sixth modified example of the example embodiment of the invention; and

FIG. 16 is a flowchart illustrating a routine for executing ignition timing control which is executed by a CPU of an ignition timing control apparatus according to a seventh modified example of the example embodiment of the invention.

### DETAILED DESCRIPTION OF EMBODIMENTS

An example embodiment and modified examples thereof of an ignition timing control apparatus of an internal combustion engine of the invention will be described below with reference to the accompanying drawings.

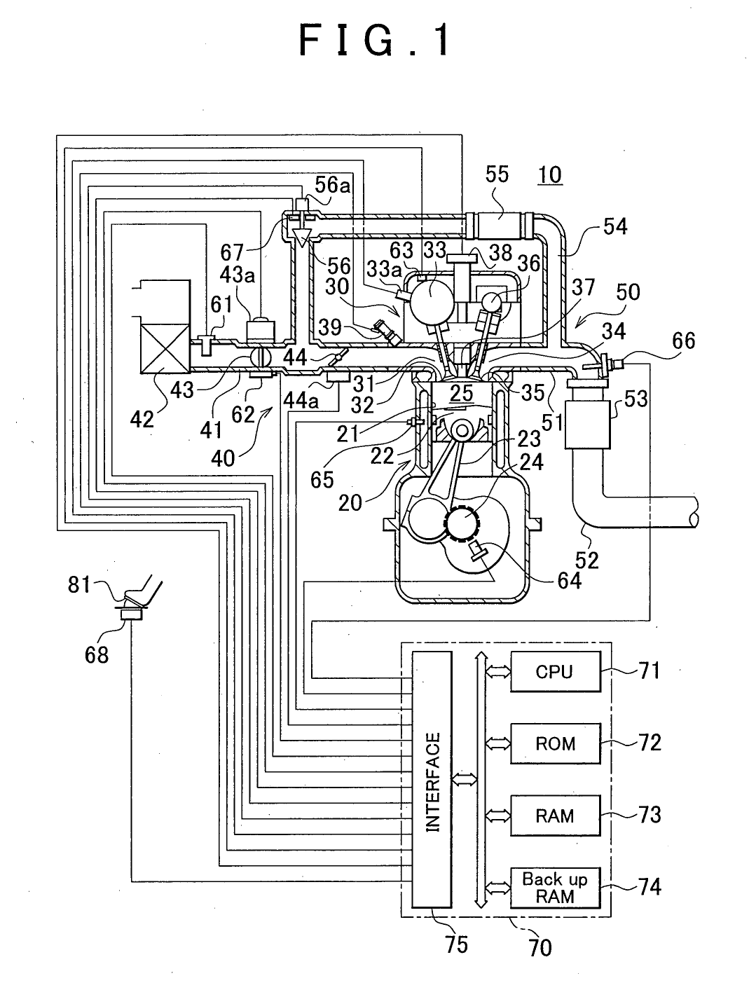

FIG. 1 is a block diagram schematically showing a system in which an ignition timing control apparatus according to an example embodiment of the invention has been applied to a spark ignition multiple cylinder (e.g., four cylinder) internal combustion engine 10. This internal combustion engine 10 includes a cylinder block portion 20 that includes a cylinder block and an oil pan and the like, a cylinder head portion 30 that is fixed on top of the cylinder block portion 20, an intake system 40 for supplying a gasoline (petrol) mixture to the cylinder block portion 20, and an exhaust system 50 for discharging exhaust gas from the cylinder block portion 20 out of the internal combustion engine 10.

The cylinder block portion 20 includes a cylinder 21, a piston 22, a connecting rod 23, and a crankshaft 24. The cylinder 21 and the head of the piston 22, together with cylinder head portion 30, define a combustion chamber 25.

The cylinder head portion 30 includes an intake port 31 which is communicated with the combustion chamber 25, an intake valve 32 that opens and closes the intake port 31, a variable intake valve timing mechanism which includes an intake camshaft that drives the intake valve 32 and which continuously changes the opening and closing timing of the intake valve 32, an actuator 33a of the variable intake valve timing mechanism 33, an exhaust port 34 which is communicated with the combustion chamber 25, an exhaust valve 35 that opens and closes the exhaust port 34, an exhaust camshaft 36 that drives the exhaust valve 35, a spark plug 37, an igniter 38 that includes an ignition coil which generates high voltage that is applied to the spark plug 37, and a fuel injection valve 39 which injects fuel into the intake port 31.

The intake system 40 includes an intake pipe 41 that includes an intake manifold which is communicated with the intake port 31 and, together with the intake port 31, forms an intake passage, an air filter 42 provided at the end of the intake pipe 41, a throttle valve 42 which is provided inside the intake pipe 41 and is able to change the open sectional area of the intake passage, a throttle valve actuator 43a that drives the throttle valve 43, a swirl control valve (SC valve) 44 that is able to change the flowrate of intake air that flows from the intake passage into the combustion chamber 25, and a SC valve actuator 44a that drives the SC valve 44.

The exhaust system 50 includes an exhaust manifold 51 which is communicated with the exhaust port 34, an exhaust pipe 52 that is connected to the exhaust manifold 51 (actually, to the portion of the exhaust manifold 51 where the portions which are communicated with the exhaust ports 34 all come together), a three way catalyst 53 that is arranged (i.e., interposed) in the exhaust pipe 52, and an EGR gas passage 54. The exhaust port 34, the exhaust manifold 51, and the exhaust pipe 52 together make up the exhaust passage.

The EGR gas passage 54 is formed by communicating the exhaust passage upstream of the three way catalyst 53 with the intake passage downstream of the throttle valve 43. An EGR gas cooler 55, an EGR valve 56, and an actuator 56a of the EGR valve 56 are all interposed in the EGR gas passage 54. The actuator 56a of the EGR valve 56 makes it possible to adjust the opening area of the EGR valve 56.

The system described above includes an airflow meter 61, a throttle position sensor 62, a cam position sensor 63, a crank position sensor 64, a coolant temperature sensor 65, an air-fuel ratio sensor 66 which is arranged in the exhaust passage upstream of the three way catalyst 53 (in this example, in the portion of the exhaust manifold 51 where the portions which are communicated with the exhaust ports 34 all come together), an EGR valve opening amount sensor 67, and an accelerator operation amount sensor 68.

The airflow meter 61 detects the flowrate (i.e., the mass flowrate) of fresh air flowing through the intake passage and outputs a signal indicative of this fresh air flowrate Ga. The throttle position sensor 62 detects the opening amount of the throttle valve 43 and outputs a signal indicative of this throttle valve opening amount TA. The cam position sensor 63 detects the opening and closing timing of the intake valve 32 and outputs a signal indicative of this opening and closing timing VVT. The crank position sensor 64 detects the rotation speed of the crankshaft 24 and outputs a signal indicative of the engine speed NE. The coolant temperature sensor 65 detects the temperature of coolant in the internal combustion engine 10 and outputs a signal indicative of this coolant temperature THW. The air-fuel ratio sensor 66 detects the air-fuel ratio of the exhaust gas and outputs a signal indicative of this air-fuel ratio. The EGR valve opening amount sensor 67 detects the opening amount of the EGR valve 56 and outputs a signal indicative of this EGR valve opening amount Aegr. The accelerator operation amount sensor 68 detects the operation amount of an accelerator pedal 81 that is operated by the driver and outputs a signal indicative of this operation amount Accp of the accelerator pedal 81.

An electronic control apparatus 70 is a microcomputer that includes, for example, a CPU 71, ROM 72 in which constants, tables (maps), and routines (programs, programmes) that are executed by the CPU 71 are stored in advance, RAM 73, backup RAM 74, and an interface 75 that includes an AD converter, all of which are connected together by a bus.

The interface 75 is connected to the sensors 61 to 68 and supplies the signals from the sensors 61 to 68 to the CPU 71, as well as outputs drive signals to the actuator 33a of the variable intake valve timing mechanism 33, the igniter 38, the fuel injection valve 39, the throttle valve actuator 43a, the SC valve actuator 44a, and the actuator 56a of the EGR valve 56 according to commands from the CPU 71.

According to the structure described above, the opening and closing timing of the intake valve 32, the opening amount of the EGR valve 56, and the opening amount of the SC valve 44 are adjusted based on the operating state (i.e., the accelerator pedal operation amount Accp and the engine speed NE). Incidentally, the amount of fresh air (i.e., the fresh intake air amount Ma) drawn into the combustion chamber (per one intake stroke), or the load ratio KL calculated from the fresh intake air amount Ma, may be used as the operating state instead of the accelerator pedal operation amount Accp. Also, the throttle valve opening amount is adjusted based on the operating state (i.e., the accelerator pedal operation amount Accp). Also, fuel of an amount corresponding to the fresh intake air amount Ma is injected from the fuel injection valve 39 at a predetermined timing (such as during the latter half of the exhaust stroke). The adjustment of the ignition timing (i.e., the timing at which the CPU 71 outputs an ignition command to the igniter 38) will be described later.

The ignition timing control apparatus according to this example embodiment is provided with an external recirculation mechanism and an internal recirculation mechanism. With the external recirculation mechanism, the amount of exhaust gas (external recirculated gas) that is recirculated from the exhaust passage to the intake passage (and therefore the combustion chamber 25) (per one intake stroke) (i.e., the external exhaust gas recirculation amount Megre) is adjusted by adjusting the opening amount of the EGR valve 56. With the internal recirculation mechanism, the amount of exhaust gas (internal recirculated gas) that is recirculated from the exhaust passage to the intake passage (and therefore the combustion chamber 25) (per one intake stroke) (i.e., the internal exhaust gas recirculation amount Megri) is adjusted by adjusting the opening and closing timing of the intake valve 32 (i.e., the overlap period OL during which both the intake and exhaust valves are open).

The combustion temperature decreases when exhaust gas is recirculated into the combustion chamber. Accordingly, the rate of combustion of the fuel inside the combustion chamber decreases and the time from when a spark is generated by the spark plug 37 until the fuel ignites (i.e., ignition delay time) becomes longer. As a result, the timing of the peak in the pressure in the combustion chamber 25 is later, which may cause problems such as a reduction in output torque or misfiring or the like.

In this case, the total amount of gas drawn into the combustion chamber 25 (per one intake stroke) will be referred to as the “total amount of gas Mc”, the total amount of exhaust gas that is recirculated into the combustion chamber 25 (per one intake stroke) by the internal and external exhaust gas recirculation mechanisms will be referred to as the “total amount of recirculated gas Megrt”, and the ratio of the total amount of recirculated gas Megrt to the total amount of gas Mc will be referred to as the “exhaust gas recirculation rate Regr”.

### Thus, Megrt=Megre+Megri, and Mc=Ma+Megrt

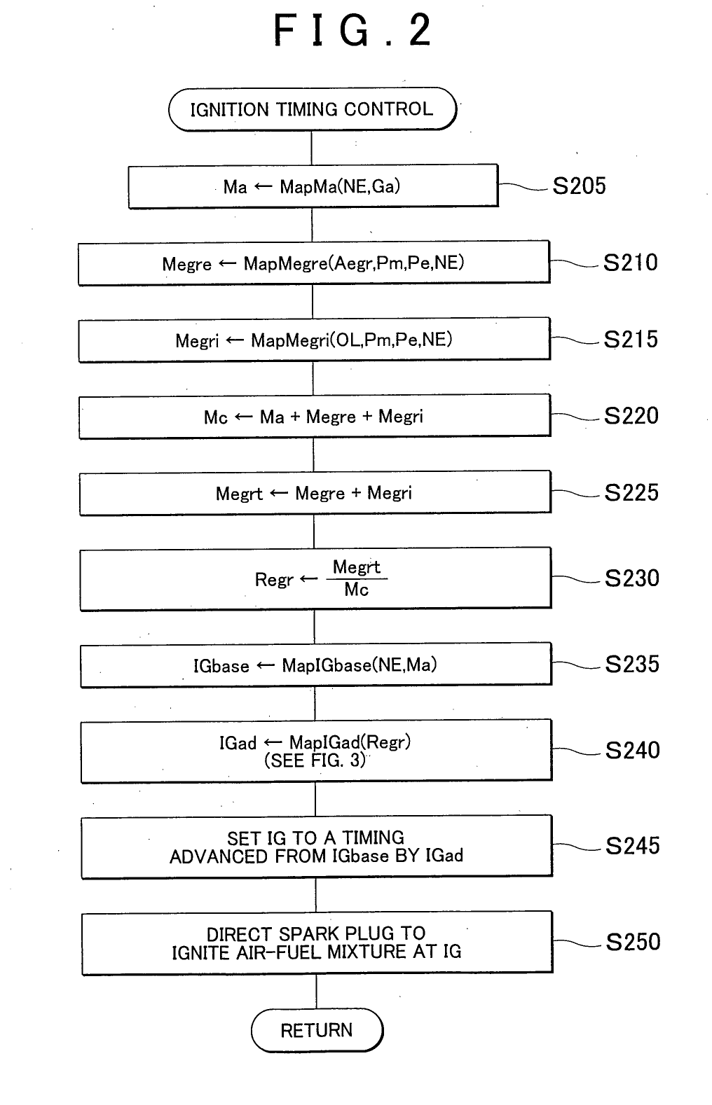

The extent to which the combustion temperature drops increases as the exhaust gas recirculation rate Regr increases, making it easier for problems such as misfiring to occur. Therefore, with the ignition timing control apparatus according to this example embodiment, the ignition timing is adjusted so that it is more advanced as the exhaust gas recirculation rate Regr increases. Hereinafter, the control of this ignition timing will be described with reference to the routine illustrated by the flowchart in FIG. 2. The routine shown in FIG. 2 is executed at each intake stroke by the CPU 71. Incidentally, hereinafter, MapX (a, b, . . . ) refers to a table (i.e., a map) prepared in advance for obtaining X, where a, b, are arguments.

First in step 205, the electronic control apparatus 70 obtains the fresh intake air amount Ma, which is the amount of fresh air drawn into the combustion chamber 25 during the current intake stroke, based on the current engine speed NE and the current fresh air flowrate Ga, and MapMa (NE, Ga).

Next in step 210, the electronic control apparatus 70 obtains the external exhaust gas recirculation amount Megre, which is the amount of external recirculated gas recirculated into the combustion chamber 25 during the current intake stroke, based on the current EGR valve opening amount Aegr, the current pressure Pm in the intake passage, the current pressure Pe in the exhaust passage, and the current engine speed NE, and MapMegre (Aegr, Pm, Pe, NE).

Then in step 215, the electronic control apparatus 70 obtains the internal exhaust gas recirculation amount Megri, which is the amount of internal recirculated gas recirculated into the combustion chamber 25 during the current intake stroke, based on the current overlap period OL, the current pressure Pm in the intake passage, the current pressure Pe in the exhaust passage, and the current engine speed NE, and MapMegri (OL, Pm, Pe, NE). Here, Pm and Pe may be directly detected by sensors, not shown, or estimated by calculations using known calculation techniques (models or the like), for example.

Then in step 220, the electronic control apparatus 70 calculates the total amount of gas Mc by adding together Ma, Megre, and Megri obtained as described above.

Next in step 225, the electronic control apparatus 70 calculates the total amount of recirculated gas Megrt by adding together Megre and Megri obtained as described above.

Then in step 230, the electronic control apparatus 70 calculates the exhaust gas recirculation rate Regr by dividing the Megrt obtained as described above by Mc.

Next in step 235, the electronic control apparatus 70 sets a base ignition timing IGbase based on the engine speed NE and the fresh intake air amount Ma, and MapIGbase (NE, Ma), The base ignition timing IGbase is the ignition timing applied when the exhaust gas recirculation rate Regre is 0.

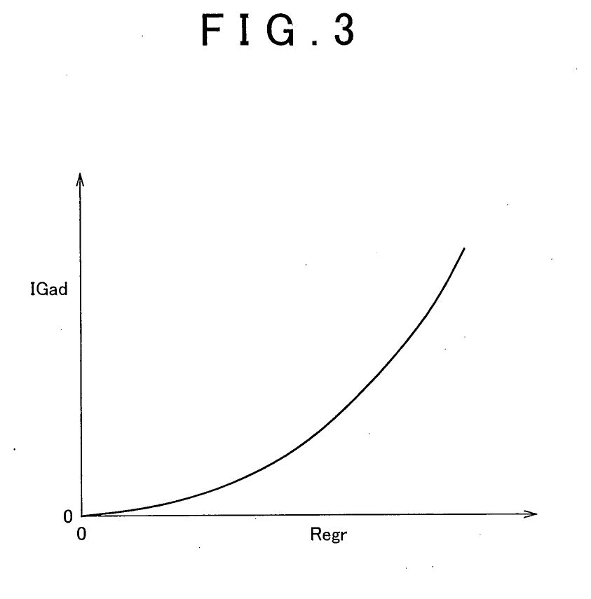

Next in step 240, the electronic control apparatus 70 sets an advance amount IGad based on the exhaust gas recirculation rate Regr and MapIGad (Regr). As shown in FIG. 3, in MapIGad (Regr), the advance amount IGad is set such that the gradient of the increase in the advance amount IGad with respect to the increase in the exhaust gas recirculation rate Regr gradually increases as the exhaust gas recirculation rate Regr increases. That is, the characteristic of the increase in the advance amount IGad with respect to the increase in the exhaust gas recirculation rate Regr is a so-called “downward convex” characteristic. The advance amount IGad is the advance amount when the ignition timing is advanced from the base ignition timing IGbase when the exhaust gas recirculation rate Regr is greater than 0. When Regr equals 0, IGad equals 0.

That is, in the next step, step 245, the electronic control apparatus 70 sets the ultimate ignition timing IG to a timing that is advanced from the IGbase by IGad.

Then in step 250, the electronic control apparatus 70 directs the spark plug 37 (i.e., the igniter 38) to ignite the air-fuel mixture in the combustion chamber 25 at the ignition timing IG.

Accordingly, the ignition timing IG is set such that the gradient of the increase in the amount that the ignition timing IG is advanced from the basic ignition timing IGbase with respect to the increase in the exhaust gas recirculation rate Regr increases as the exhaust gas recirculation rate Regr increases. Hereinafter, the operation and effects from setting the ignition timing IG in this way will be described.

Typically, the rate of combustion slows and the ignition delay time becomes longer as the exhaust gas recirculation rate increases. However, in the operating region where the exhaust gas recirculation rate is particularly high, there is a tendency for the rate of combustion of the fuel to rapidly decrease and the ignition delay time to become drastically longer as the exhaust gas recirculation rate increases. Therefore, if the advance amount IGad is set such that the gradient of the increase in the advance amount IGad with respect to the increase in the exhaust gas recirculation rate Regr is constant regardless of the exhaust gas recirculation rate Regr (i.e., if the advance amount IGad is set such that the characteristic of the increase in the advance amount IGad with respect to the increase in the exhaust gas recirculation rate Regr is expressed as a straight line), it is not possible to simultaneously solve the problem of an insufficient advance amount in the operating region where the exhaust gas recirculation rate is particularly high and the problem of an excessive advance amount in the operating region where the exhaust gas recirculation rate is particularly low no matter how the gradient (constant) of the increase in the advance amount IGad is set.

However, with the ignition timing control apparatus according to this example embodiment, the characteristic of the increase in the advance amount IGad with respect to the increase in the exhaust gas recirculation rate Regr is a so-called “downward convex” characteristic (see FIG. 3). As a result, the characteristic of the increase in the advance amount with respect to the increase in the exhaust gas recirculation rate can be set such that the advance amount is substantially large in the region where the exhaust gas recirculation rate is particularly high and sufficiently small in the region where the exhaust gas recirculation rate is particularly low. Therefore, it is possible to simultaneously solve both the problems of an insufficient advance amount in the operating region where the exhaust gas recirculation rate is particularly high and an excessive advance amount in the operating region where the exhaust gas recirculation rate is particularly low.

That is, the advance amount IGad can be set to a suitable value that is neither too large nor too small, regardless of the exhaust gas recirculation rate Regr. Therefore, an ignition timing IG can be set that makes it possible to stably suppress a decrease in output torque, as well as knocking and misfiring and the like, regardless of the exhaust gas recirculation rate Regr.

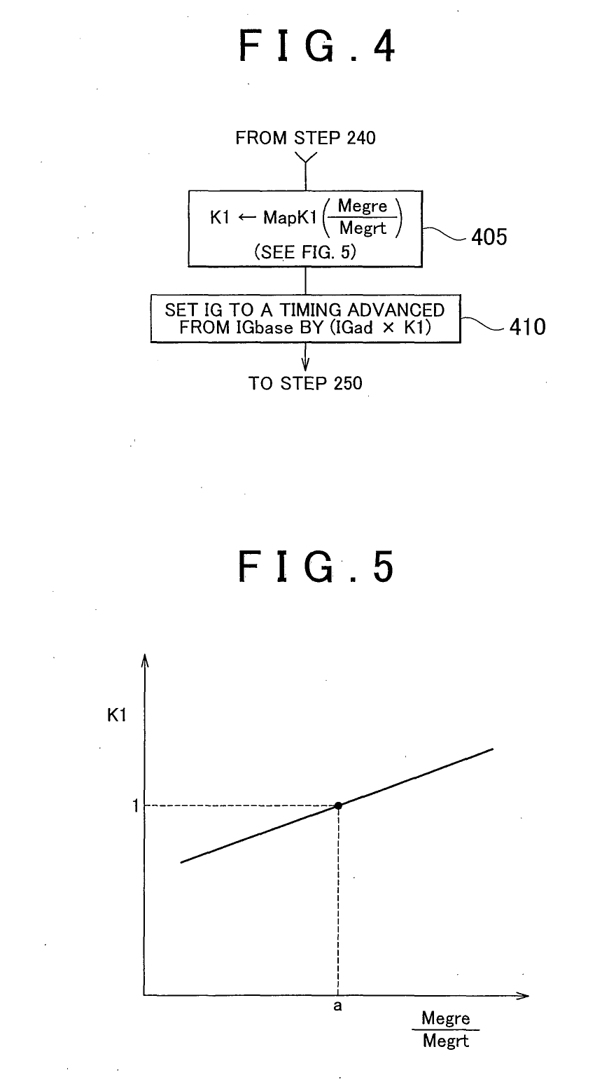

The invention is not limited to the example embodiment described above. That is, various modified examples may also be employed within the scope of the invention. For example, step 245 in the routine shown in FIG. 2 may be replaced by steps 405 and 410, as in a first modified example of the example embodiment of the invention shown in FIG. 4. In the following description, Megre/Megrt will be referred to as the “external exhaust gas recirculation rate”.

In step 405, the electronic control apparatus 70 obtains a coefficient K1 (>0) using MapK1 (Megre/Megrt) shown in FIG. 5. As shown in FIG. 5, the coefficient K1 is set to a larger value the higher the external exhaust gas recirculation rate Regre is. In this case, the value A is a value in which the external exhaust gas recirculation rate is kept constant throughout a compliance test of the advance amount IGad that is performed to create MapIGad (Regr) shown in FIG. 3.

In step 410, the electronic control apparatus 70 sets the ultimate ignition timing IG to a timing that is advanced from the base ignition timing IGbase by IGad×K1. That is, IGad×K1 is used instead of the advance amount IGad as the advance amount from the base ignition timing IGbase. As a result, the advance amount is set to a larger value, and thus the ignition timing IG is set to a timing that is more advanced, the higher the external exhaust gas recirculation rate is when the exhaust gas recirculation rate Regr is constant. The reason for correcting the ignition timing IG using the coefficient K1 in this way will be described below.

The electronic control apparatus 70 compares the temperatures of the external recirculated gas and the internal recirculated gas. The external recirculated gas is gas that is recirculated from the exhaust passage to the intake passage (and therefore the combustion chamber 25) through the EGR gas passage 54 which has the EGR gas cooler 55 interposed therein. Therefore, the temperature of the external recirculated gas is relatively low. On the other hand, the internal recirculated gas is gas that is recirculated from the exhaust passage to the intake passage (and therefore the combustion chamber 25) through the combustion chamber 25 which is at a high temperature. Therefore, the temperature of the internal recirculated gas is relatively high. That is, the temperature of the external recirculated gas is lower than the temperature of the internal recirculated gas. Accordingly, the compression end temperature decreases as the external exhaust gas recirculation rate Regre increases when the exhaust gas recirculation rate Regr is constant. When the compression end temperature decreases, the combustion temperature also decreases so the rate of combustion becomes slower and the ignition delay time becomes longer.

Therefore, in this modified example, the ignition timing is set to a timing that is more advanced the higher the external exhaust gas recirculation rate is when the exhaust gas recirculation rate Regr is constant. Thus, the ignition timing IG is corrected using the coefficient K1. As a result, problems such as misfiring can be inhibited even more when the external exhaust gas recirculation rate Regre is particularly high.

In the modified example shown in FIG. 4, the ultimate advance amount (=IGad×K1) is set by obtaining the advance amount IGad using MapIGad (Regr) shown in FIG. 3, and then correcting this advance amount IGad with the coefficient K1 obtained using MapK1 (Megre/Megrt) shown in FIG. 5. However, an ultimate advance amount IGad that corresponds to IGad×K1 may also be set at a given time using MapIGad (Regr, Megre/Megrt).

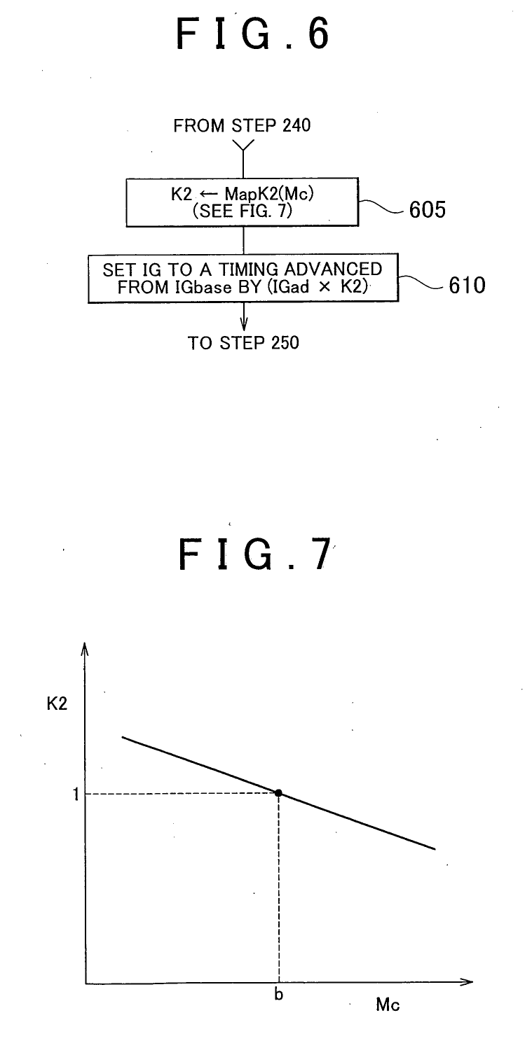

Also, step 245 in the routine shown in FIG. 2 may also be replaced by steps 605 and 610, as in a second modified example of the example embodiment of the invention shown in FIG. 6.

In step 605, the electronic control apparatus 70 obtains a coefficient K2 (>0) using MapK2 (Mc) shown in FIG. 7. As is evident from FIG. 7, the coefficient K2 is set to a larger value the smaller the total amount of gas Mc is. In this case, the value b is a value in which the total amount of gas Mc is kept constant throughout the compliance test of the advance amount IGad that is performed to create MapIGad (Regr) shown in FIG. 3.

In step 610, the electronic control apparatus 70 sets the ultimate ignition timing IG to a timing that is advanced from the base ignition timing IGbase by IGad×K2. That is, IGad×K2 is used instead of the advance amount IGad as the advance amount from the base ignition timing IGbase. As a result, the advance amount is set to a larger value, and thus the ignition timing IG is set to a timing that is more advanced, the smaller the total amount of gas Mc is when the exhaust gas recirculation rate Regr is constant. The reason for correcting the ignition timing IG using the coefficient K2 in this way will be described below.

Typically, the compression end temperature tends to decrease as the total amount of gas Mc becomes smaller. Accordingly, in this modified example, the ignition timing is set to a timing that is more advanced the smaller the total amount of gas Mc is when the exhaust gas recirculation rate Regr is constant. Thus, the ignition timing IG is corrected using the coefficient K2. As a result, problems such as misfiring can be inhibited even more when the total amount of gas Mc is particularly small.

In the modified example shown in FIG. 6, the ultimate advance amount (=IGad×K2) is set by obtaining the advance amount IGad using MapIGad (Regr) shown in FIG. 3, and then correcting this advance amount IGad with the coefficient K2 obtained using MapK2 (Mc) shown in FIG. 7. However, an ultimate advance amount IGad that corresponds to IGad×K2 may also be set at a given time using MapIGad (Regr, Mc).

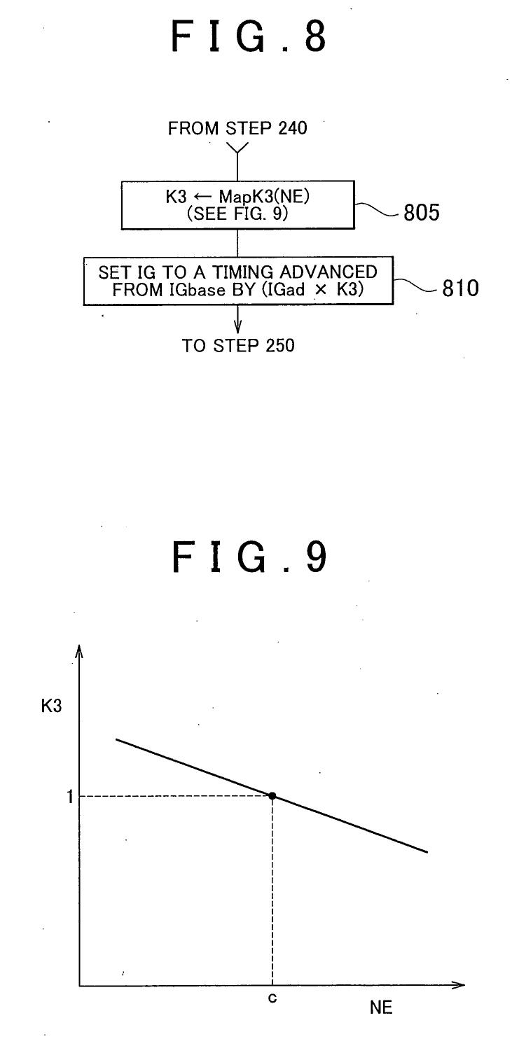

Also, step 245 in the routine shown in FIG. 2 may also be replaced by steps 805 and 810, as shown in a third modified example of the example embodiment of the invention shown in FIG. 8.

In step 805, the electronic control apparatus 70 obtains a coefficient K3 (>0) using MapK3 (NE) shown in FIG. 9. As is evident from FIG. 9, the coefficient K3 is set to a larger value the lower the engine speed NE is. In this case, the value c is a value in which the engine speed NE is kept constant throughout the compliance test of the advance amount IGad that is performed to create MapIGad (Regr) shown in FIG. 3.

In step 810, the electronic control apparatus 70 sets the ultimate ignition timing IG to a timing that is advanced from the base ignition timing IGbase by IGad×K3. That is, IGad×K3 is used instead of the advance amount IGad as the advance amount from the base ignition timing IGbase. As a result, the advance amount is set to a larger value, and thus the ignition timing IG is set to a timing that is more advanced, the lower the engine speed NE is when the exhaust gas recirculation rate Regr is constant. The reason for correcting the ignition timing IG using the coefficient K3 in this way will be described below.

The compression stroke takes longer the lower the engine speed NE is. This means that more heat from the compressed gas inside the combustion chamber escapes to the outside through the walls of the combustion chamber. As a result, the compression end temperature decreases as the engine speed NE decreases. Accordingly, in this modified example, the ignition timing is set to a timing that is more advanced the lower the engine speed NE is when the exhaust gas recirculation rate Regr is constant. Thus, the ignition timing IG is corrected using the coefficient K3. As a result, problems such as misfiring can be inhibited even more when the engine speed NE is particularly low.

In the modified example shown in FIG. 8, the ultimate advance amount (=IGad×K3) is set by obtaining the advance amount IGad using MapIGad (Regr) shown in FIG. 3, and then correcting this advance amount IGad with the coefficient K3 obtained using MapK3 (NE) shown in FIG. 9. However, an ultimate advance amount IGad that corresponds to IGad×K3 may also be set at a given time using MapIGad (Regr, NE).

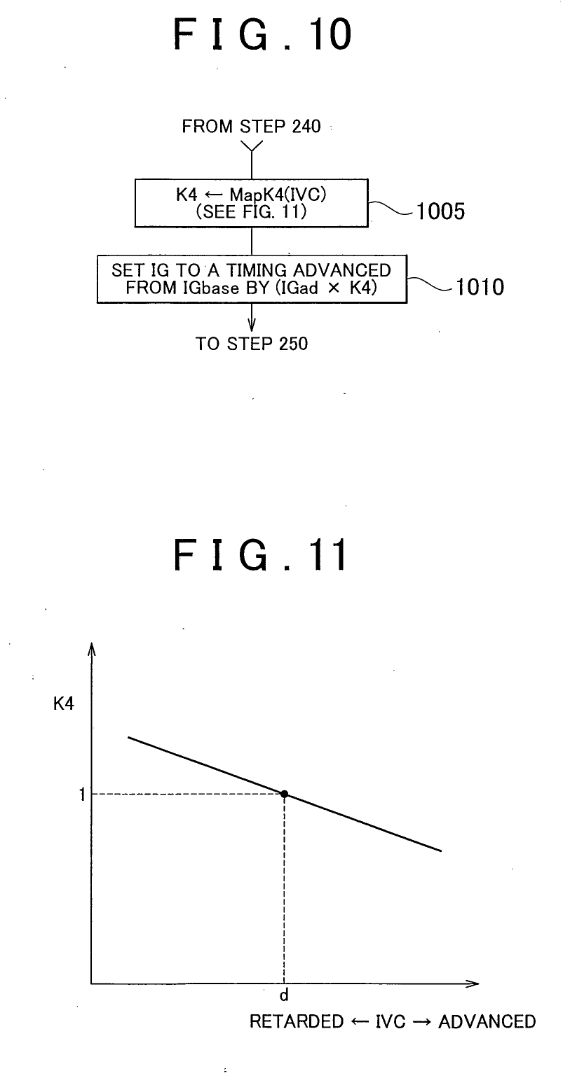

Also, step 245 in the routine shown in FIG. 2 may also be replaced by steps 1005 and 1010, as shown in a fourth modified example of the example embodiment of the invention shown in FIG. 10. In the following description, the closing timing of the intake valve 32 will be referred to as “IVC”.

In step 1005, the electronic control apparatus 70 obtains a coefficient K4 (>0) using MapK4 (IVC) shown in FIG. 11. As is evident from FIG. 11, the coefficient K4 is set to a larger value the more IVC is retarded. In this case, the value d is a value (i.e., a timing) in which IVC is kept constant throughout the compliance test of the advance amount IGad that is performed to create MapIGad (Regr) shown in FIG. 3.

In step 1010, the electronic control apparatus 70 sets the ultimate ignition timing IG to a timing that is advanced from the base ignition timing IGbase by IGad×K4. That is, IGad×K4 is used instead of the advance amount IGad as the advance amount from the base ignition timing IGbase, As a result, the advance amount is set to a larger value, and thus the ignition timing IG is set to a timing that is more advanced, the more retarded IVC is when the exhaust gas recirculation rate Regr is constant. The reason for correcting the ignition timing IG using the coefficient K4 in this way will be described below.

The timing (i.e., crank angle) at which the gas inside the combustion chamber starts to be compressed during the compression stroke is later the more retarded IVC is. This means that the actual compression ratio becomes smaller. Therefore, the compression end temperature is lower the more retarded IVC is. Accordingly, in this modified example, the ignition timing is set to a timing that is more advanced the more retarded IVC is when the exhaust gas recirculation rate Regr is constant. Thus, the ignition timing IG is corrected using the coefficient K4. As a result, problems such as misfiring can be inhibited even more when IVC is particularly retarded.

In the modified example shown in FIG. 10, the ultimate advance amount (=IGad×K4) is set by obtaining the advance amount IGad using MapIGad (Regr) shown in FIG. 3, and then correcting this advance amount IGad with the coefficient K4 obtained using MapK4 (IVC) shown in FIG. 11. However, an ultimate advance amount IGad that corresponds to IGad×K4 may also be set at a given time using MapIGad (Regr, IVC).

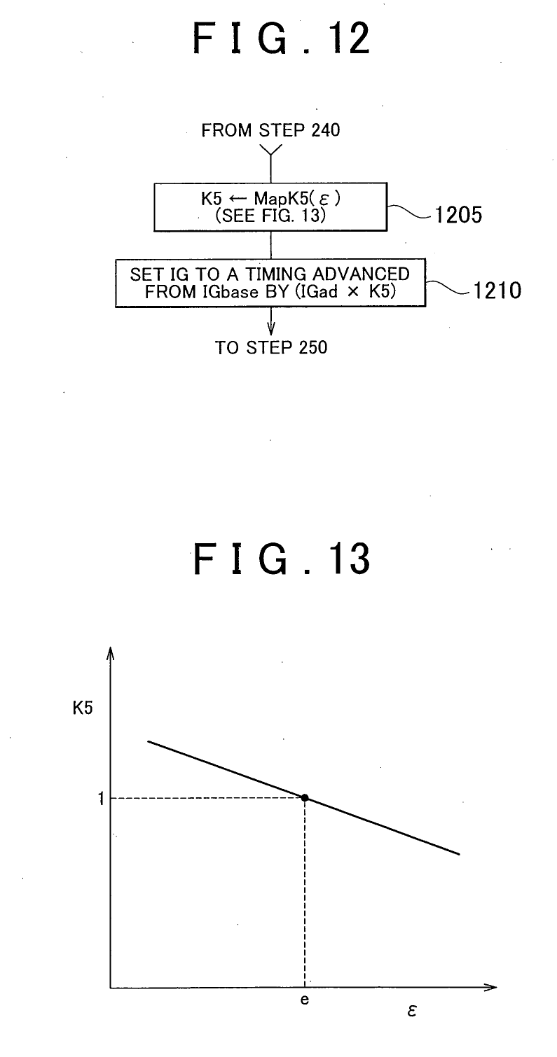

Also, when the internal combustion engine is provided with an engine compression ratio control mechanism that changes the engine compression ratio according to the operating state, step 245 in the routine shown in FIG. 2 may be replaced by steps 1205 and 1210, as in a fifth modified example of the example embodiment of the invention shown in FIG. 12. The engine compression ratio c is a value obtained by dividing the volume of the combustion chamber 25 at bottom dead center (BDC) of the compression stroke by the volume of the combustion chamber 25 at top dead center (TDC) of the compression stroke. Any known engine compression ratio control mechanism, such as one which changes the stroke of the piston 22 or one which changes the shape of the combustion chamber 25, may be used as the engine compression ratio control mechanism. The structures of these engine compression ratio control mechanisms are well known so they will not be described in detail.

In step 1205, the electronic control apparatus 70 obtains a coefficient K5 (>0) using MapK5 (s) shown in FIG. 13. As is evident from FIG. 13, the coefficient K5 is set to a larger value the smaller ε is, In this case, the value e is a value in which c is kept constant throughout the compliance test of the advance amount IGad that is performed to create MapIGad (Regr) shown in FIG. 3.

In step 1210, the electronic control apparatus 70 sets the ultimate ignition timing IG to a timing that is advanced from the base ignition timing IGbase by IGad×K5. That is, IGad×K5 is used instead of the advance amount IGad as the advance amount from the base ignition timing IGbase. As a result, the advance amount is set to a larger value, and thus the ignition timing IG is set to a timing that is more advanced, the smaller ε is when the exhaust gas recirculation rate Regr is constant. The reason for correcting the ignition timing IG using the coefficient K5 in this way will be described below.

The compression end temperature decreases as the engine compression ratio becomes smaller. Accordingly, in this modified example, the ignition timing is set to a timing that is more advanced the smaller ε is when the exhaust gas recirculation rate Regr is constant. Thus, the ignition timing IG is corrected using the coefficient K5. As a result, problems such as misfiring can be inhibited even more when the engine compression ratio ε is particularly small.

In the modified example shown in FIG. 12, the ultimate advance amount (=IGad×K5) is set by obtaining the advance amount IGad using MapIGad (Regr) shown in FIG. 3, and then correcting this advance amount IGad with the coefficient K5 obtained using MapK5 (c) shown in FIG. 13. However, an ultimate advance amount IGad that corresponds to IGad×K5 may also be set at a given time using MapIGad (Regr, ε).

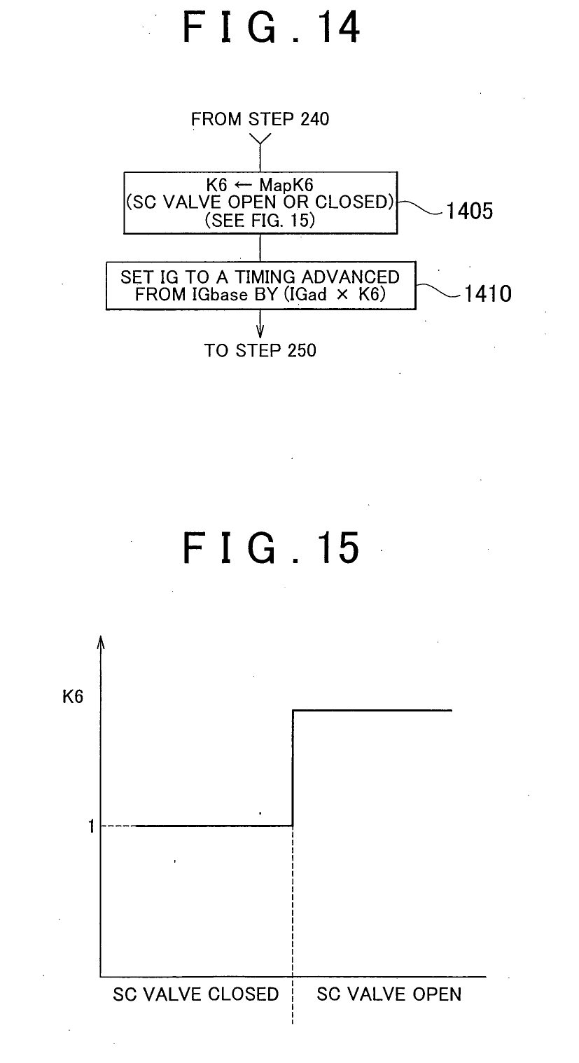

Also, step 245 in the routine shown in FIG. 2 may be replaced by steps 1405 and 1410, as in a sixth modified example of the example embodiment of the invention shown in FIG. 14. In this example, two intake valves 32 are provided for each cylinder. A partition wall for separating the intake passage into two passages leading to the intake valves 32 is provided along the intake passage at a portion near the intake valves 32 in the intake passage. The SC valve 44 that is used is one which is selectively opened or closed depending on the operating state. When the SC valve 44 is closed, one of the two passages leading to the two intake valves 32 is blocked off. When the SC valve 44 is open, neither of the two passages leading to the two intake valves 32 are blocked off. That is, when the SC valve 44 is open, the minimum opening area of the intake passage (downstream of the throttle valve 43) is large so the flowrate of the intake air that flows from the intake passage into the combustion chamber 25 is small. On the other hand, when the SC valve 44 is closed, the minimum opening area of the intake passage (downstream of the throttle valve 43) is small so the flowrate of the intake air that flows from the intake passage into the combustion chamber 25 is large.

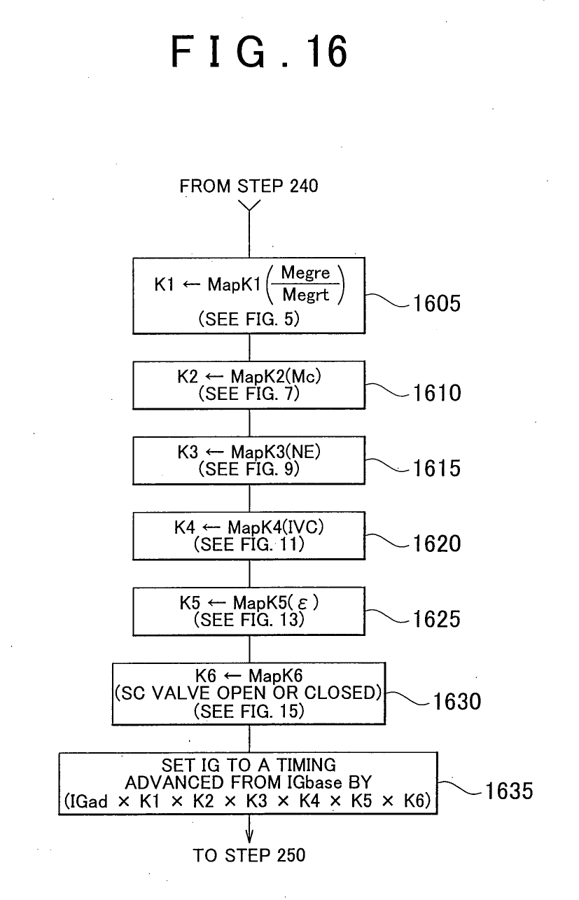

In step 1405, the electronic control apparatus 70 obtains a coefficient K6 (>0) using MapK6 (SC valve open or closed) shown in FIG. 15. As is evident from FIG. 15, the coefficient K6 is set to 1 when the SC valve 44 is closed and a value greater than 1 when the SC valve 44 is open. The SC valve 44 is kept closed throughout the compliance test of the advance amount IGad that is performed to create MapIGad (Regr) shown in FIG. 3.

In step 1410, the electronic control apparatus 70 sets the ultimate ignition timing IG to a timing that is advanced from the base ignition timing IGbase by IGad×K6. That is, IGad×K6 is used instead of the advance amount IGad as the advance amount from the base ignition timing IGbase. As a result, the advance amount is set to a larger value, and thus the ignition timing IG is set to a timing that is more advanced, when the SC valve 44 is open when the exhaust gas recirculation rate Regr is constant, The reason for correcting the ignition timing IG using the coefficient K6 in this way will be described below.

The turbulence of the gas that is drawn into the combustion chamber decreases as the flowrate of the intake air decreases. As the turbulence of the gas decreases, the opportunity for fuel to come into contact with oxygen in the combustion chamber decreases, so the rate of combustion slows and the ignition delay time becomes longer. Accordingly, in this modified example, the ignition timing is set to a timing that is more advanced when the SC valve 44 is open when the exhaust gas recirculation rate Regr is constant. Thus, the ignition timing IG is corrected using the coefficient K6. As a result, problems such as misfiring can be inhibited even more when the SC valve 44 is open and the flowrate of the intake air is small.

In the modified example shown in FIG. 14, the ultimate advance amount (=IGad×K6) is set by obtaining the advance amount IGad using MapIGad (Regr) shown in FIG. 3, and then correcting this advance amount IGad with the coefficient K6 obtained using MapK6 (SC valve open or closed) shown in FIG. 15. However, an ultimate advance amount IGad that corresponds to IGad×K6 may also be set at a given time using MapIGad (Regr, SC valve open or closed).

Also, the SC valve 44 used in this modified example is one which is selectively closed or opened depending on the operating state. Alternatively, however, the SC valve that is used may instead be one which is able to gradually change the minimum opening area of the intake passage according to the operating state. In this case, a table which sets the coefficient K6 (>0) such that the coefficient K6 gradually increases as the minimum opening area increases may be used instead of MapK (SC valve open or closed) shown in FIG. 15.

Also, step 245 in the routine shown in FIG. 2 may also be replaced by steps 1605 and 1610, as shown in a seventh modified example of the example embodiment of the invention shown in FIG. 16. That is, taking all of the coefficients K1 to K6 described above into account, IGad×K1×K2,×K3,×K4,×KS×K6 may be used instead of IGad as the advance amount from the base ignition timing IGbase. Also, the advance amount from the base ignition timing IGbase may be calculated taking into account two to five of the coefficients from among the coefficients K1 to K6.

Also, in the modified examples described above, the ultimate advance amount is calculated by multiplying the coefficient by the advance amount IGad, and then ignition timing IG is corrected using that ultimate advance amount. Alternatively, however, the ultimate advance amount may be calculated by adding a correction amount that is equivalent to the coefficient to the advance amount IGad, and then the ignition timing IG may be corrected using that ultimate advance amount.

Also, in this example embodiment, the base ignition timing IGbase is obtained in step 235 in FIG. 2, and the ultimate ignition timing IG is set to a timing that is advanced from the base ignition timing IGbase by the advance amount IGad. Alternatively, however, an ultimate ignition timing IG that takes into account the base ignition timing IGbase and the advance amount IGad may be set at a given time using MapIG (NE, Ma, Regr).

Also, in this example embodiment, the advance amount IGad is set so that the gradient of the increase in the advance amount IGad with respect to the increase in the exhaust gas recirculation rate Regr gradually increases as the exhaust gas recirculation rate Regr increases, as shown in FIG. 3. That is, the characteristic of the increase in the advance amount IGad with respect to the increase in the exhaust gas recirculation rate Regr is a so-called “downward convex” characteristic. Instead of this, however, the advance amount IGad may be set such that the gradient of the increase in the advance amount IGad is constant at a first gradient when Regr is equal to or less than a first predetermined value, and is constant at a second gradient which is greater than the first gradient when Regr is greater than the first predetermined value. That is, the characteristic of the increase in the advance amount IGad with respect to the exhaust gas recirculation rate Regr may be a characteristic that is expressed by a broken line formed by two line segments which resembles the downward convex characteristic shown in FIG. 3. Also, the characteristic of the increase in the advance amount IGad with respect to the increase in the exhaust gas recirculation rate Regr may be a characteristic that is expressed by a broken line formed by three or more line segments which resembles the downward convex characteristic shown in FIG. 3.

In addition, in the example embodiment described above, both the external recirculation mechanism and the internal recirculation mechanism are provided. However, the invention may also be applied to an internal combustion engine provided with only one of those recirculation mechanisms, i.e., only the external recirculation mechanism or only the internal recirculation mechanism.

While the invention has been described with reference to example embodiments thereof, it is to be understood that the invention is not limited to the described embodiments or constructions. To the contrary, the invention is intended to cover various modifications and equivalent arrangements. In addition, while the various elements of the described invention are shown in various example combinations and configurations, other combinations and configurations, including more, less or only a single element, are also within the scope of the appended claims.

1-10. (canceled)

11. An ignition timing control apparatus of an internal combustion engine, comprising:
an exhaust gas recirculation mechanism that recirculates exhaust gas discharged from a combustion chamber of the internal combustion engine into the combustion chamber, and
an ignition timing setting portion that sets an ignition timing, which is the timing at which an air-fuel mixture is ignited in the combustion chamber, based on an operating state of the internal combustion engine,
wherein the ignition timing setting portion includes an exhaust gas recirculation rate calculating portion that calculates an exhaust gas recirculation rate which is the ratio of the total amount of recirculated exhaust gas, which is the total amount of exhaust gas recirculated into the combustion chamber by the exhaust gas recirculation mechanism, with respect to the total amount of gas which is the total amount of gas drawn into the combustion chamber,
wherein the ignition timing setting portion sets the ignition timing such that a gradient of an increase in the amount that the ignition timing which is advanced with respect to an increase in the exhaust gas recirculation rate calculated by the exhaust gas recirculation rate calculating portion increases as the exhaust gas recirculation rate calculated by the exhaust gas recirculation rate calculating portion increases,
wherein the exhaust gas recirculation mechanism includes i) an external recirculation mechanism that controls the amount of exhaust gas recirculated from an exhaust gas passage of the internal combustion engine to an intake passage of the internal combustion engine through an exhaust gas recirculation passage that communicates the exhaust passage with the intake passage, by controlling the opening amount of an exhaust gas recirculation valve interposed in the exhaust gas recirculation passage, and ii) an internal recirculation mechanism that controls the amount of exhaust gas recirculated from the exhaust passage to the intake passage through the combustion chamber by controlling the length of time for which an intake valve and an exhaust valve of the internal combustion engine are both kept open simultaneously,
wherein the ignition timing setting means includes an external exhaust gas recirculation rate calculating portion calculates an external exhaust gas recirculation rate which is the ratio of an external exhaust gas recirculation amount, which is the amount of exhaust gas recirculated into the combustion chamber by the external recirculation mechanism, with respect to the total amount of recirculated exhaust gas which is the sum of the external exhaust gas recirculation amount and an internal exhaust gas recirculation amount which is the amount of exhaust gas recirculated into the combustion chamber by the internal recirculation mechanism,
wherein the ignition timing setting portion sets the ignition timing to a timing that is more advanced the higher the external exhaust gas recirculation rate is.

12. The ignition timing control apparatus according to claim 11, wherein the ignition timing setting portion sets the ignition timing to a timing that is more advanced the smaller the total amount of gas is.

13. The ignition timing control apparatus according to claim 11, wherein:
the ignition timing setting portion includes an operating speed obtaining portion that obtains an operating speed of the internal combustion engine; and
the ignition timing setting portion sets the ignition timing to a timing that is more advanced the lower the operating speed is.

14. The ignition timing control apparatus according to any one of claim 11, wherein:
the ignition timing setting portion includes an intake valve closing timing control mechanism for that changes the closing timing of the intake valve based on the operating state of the internal combustion engine; and
the ignition timing setting portion sets the ignition timing to a timing that is more advanced the more retarded the closing timing of the intake valve is.

15. The ignition timing control apparatus according to claim 11, wherein:
the ignition timing setting portion includes an engine compression ratio control mechanism that changes an engine compression ratio, which is a value obtained by dividing the volume of the combustion chamber at bottom dead center of a compression stroke by the volume of the combustion chamber at top dead center of the compression stroke, based on the operating state of the internal combustion engine; and
the ignition timing setting portion sets the ignition timing to a timing that is more advanced the smaller the engine compression ratio is.

16. The ignition timing control apparatus according to claim 11, wherein:
the ignition timing setting portion includes a flowrate control mechanism that changes the flowrate of gas that flows from the intake passage into the combustion chamber, based on the operating state of the internal combustion engine; and
the ignition timing setting portion sets the ignition timing to a timing that is more advanced the smaller the flowrate is.

17. The ignition timing control apparatus according to claim 16, wherein the flowrate control mechanism changes the flowrate of gas that flows into the combustion chamber by changing i) the number of valves, from among a plurality of the intake valves, that are open or ii) the minimum opening area of the intake passage.

18. A control method of an ignition timing control apparatus of an internal combustion engine, which includes an exhaust gas recirculation mechanism that recirculates exhaust gas discharged from a combustion chamber of the internal combustion engine into the combustion chamber, and an ignition timing setting portion that sets an ignition timing, which is the timing at which an air-fuel mixture is ignited in the combustion chamber, based on an operating state of the internal combustion engine, wherein the exhaust gas recirculation mechanism includes i) an external recirculation mechanism that controls the amount of exhaust gas recirculated from an exhaust gas passage of the internal combustion engine to an intake passage of the internal combustion engine through an exhaust gas recirculation passage that communicates the exhaust passage with the intake passage, by controlling the opening amount of an exhaust gas recirculation valve interposed in the exhaust gas recirculation passage, and ii) an internal recirculation mechanism that controls the amount of exhaust gas recirculated from the exhaust passage to the intake passage through the combustion chamber by controlling the length of time for which an intake valve and an exhaust valve of the internal combustion engine are both kept open simultaneously, the control method comprising:
calculating an exhaust gas recirculation rate which is the ratio of the total amount of recirculated exhaust gas, which is the total amount of exhaust gas recirculated into the combustion chamber by the exhaust gas recirculation mechanism, with respect to the total amount of gas which is the total amount of gas drawn into the combustion chamber;
setting the ignition timing such that a gradient of an increase in the amount that the ignition timing which is advanced with respect to an increase in the calculated exhaust gas recirculation rate increases as the calculated exhaust gas recirculation rate calculated increases;
calculating an external exhaust gas recirculation rate which is the ratio of an external exhaust gas recirculation amount, which is the amount of exhaust gas recirculated into the combustion chamber by the external recirculation mechanism, with respect to the total amount of recirculated exhaust gas which is the sum of the external exhaust gas recirculation amount and an internal exhaust gas recirculation amount which is the amount of exhaust gas recirculated into the combustion chamber by the internal recirculation mechanism; and
setting with the ignition timing setting portion the ignition timing to a timing that is more advanced the higher the external exhaust gas recirculation rate is.
